(19) United States
(12) Patent Application Publication
(10) Pub. No.: US 2005/0062930 A1
(43) Pub. Date: Mar. 24, 2005

(54) Safety spectacles

(76) Inventor: Jeau-Chuan Lin, Taichung City (TW)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/869,858

(22) Filed: Jun. 18, 2004

(30) Foreign Application Priority Data
Sep. 23, 2003 (TW) 092217039

(51) Int. Cl. G02C 7/14

(52) U.S. Cl. 351/50

(57) ABSTRACT

A pair of safety spectacles include a spectacle frame, two extension legs, two spectacle lenses, and at least one reflecting lens. The extension legs are respectively extended from two sides of the spectacle frame for the user to wear the spectacles via the extension legs. The spectacle lenses are held by the spectacle frame and correspond in position to the user's eyes. The reflecting lens is formed on at least one of the spectacle lenses, such that the user see a front view through the spectacle lenses and see a rear view via the reflecting lens, thereby providing a broadened view angle for the user. The spectacles can be put into mass production with low cost.

### FIELD OF THE INVENTION

The invention relates to safety spectacles, and more particularly, to a pair of safety spectacles using reflecting lenses.

### BACKGROUND OF THE INVENTION

Human can only see the front views as limited by a view angle of eyes and need to inconveniently turn his or her neck to catch side views or rear views. The view angle may be slightly expanded due to turning of eyeballs, which however varies among different persons, and it is difficult for a person to have intensive attention to the side views. Moreover, the person must turn his or her neck to see the rear views, and this action may cause risk in driving such as accident or in safety concern such as stealing.

Reflecting mirrors mounted at two opposite sides of a vehicle or motorcycle provide visual aids for a driver and help the driver to instantly realize the traffic condition while driving without having to turn the neck backwards. However, a pedestrian who has no auxiliary tool to notice any traffic condition is still in danger of accidents. Therefore, it is desired to develop an easy and convenient visual aid for the pedestrian in traffic.

Moreover, besides the traffic or accident problem, the dangers caused behind the pedestrians or drivers also include stealing or frightening attacks at night due to the limitation of human eyes on seeing the front views only, making them easily hurt at the rear and side directions. The unconscious conditions at the rear and side directions are not easily controlled, thereby increasing the inconvenience and danger in daily life.

Besides avoiding the foregoing accidents and danger, using an auxiliary tool to provide a wide view angle is also important and convenient in daily life at the time when measuring a distance or adjusting the arrangement or location of articles is required for the person without turning the neck.

Therefore, the problem to be solved here is to provide a pair of safety spectacles, which can provide a wide view angle for a user to easily notice the views at any direction to prevent accidents or danger, and which can be put into mass production with low cost.

### SUMMARY OF THE INVENTION

A primary objective of the present invention is to provide a pair of safety spectacles that can provide a wide view angle.

Another objective of the present invention is to provide a pair of safety spectacles that are useful for a user to prevent accidents or danger from any direction.

Still another objective of the present invention is to provide a pair of safety spectacles that are simply fabricated and can be put into mass production.

A further objective of the present invention is to provide a pair of safety spectacles made with low cost.

In order to achieve the above and other objectives, the present invention proposes a pair of safety spectacles comprising a spectacle frame; two extension legs respectively extended from sides of the spectacle frame to allow a user to wear the spectacles via the extension legs; two spectacle lenses held by the spectacle frame and positioned corresponding to the user's eyes to allow the user to see a front view through the spectacle lenses; and at least one reflecting lens formed on at least one of the spectacle lenses, making the user see a rear view via the reflecting lens.

The reflecting lens can be attached to or fastened on the spectacle lens, and is located on a surface of the spectacle lens that faces the user's eyes. The reflecting lens is located at an edge of the spectacle lens close to the extension leg and within the range of a view angle of the user's eyes. A reflecting surface of the reflecting lens faces the user and is a flat surface.

Therefore, the safety spectacles in the present invention provide a broadened view angle for a user to notice any accidents immediately and prevent any danger from occurrence. Furthermore, the spectacles are easily manufactured with low cost. As a result, the drawbacks in the prior art can be eliminated.

### BRIEF DESCRIPTION OF THE DRAWINGS

The present invention can be more fully understood by reading the following detailed description of the preferred embodiments, with reference made to the accompanying drawings, wherein:

FIG. 1A and FIG. 1B are schematic views of a pair of safety spectacles according to a preferred embodiment of the present invention;

FIG. 2 is a side view of the spectacles according to the preferred embodiment of the present invention;

FIG. 3 is a schematic view showing the spectacles in use according to the preferred embodiment of the present invention; and

FIG. 4 is a schematic view of a pair of spectacles according to another preferred embodiment of the present invention.

### DETAILED DESCRIPTION OF THE PREFERRED EMBODIMENTS

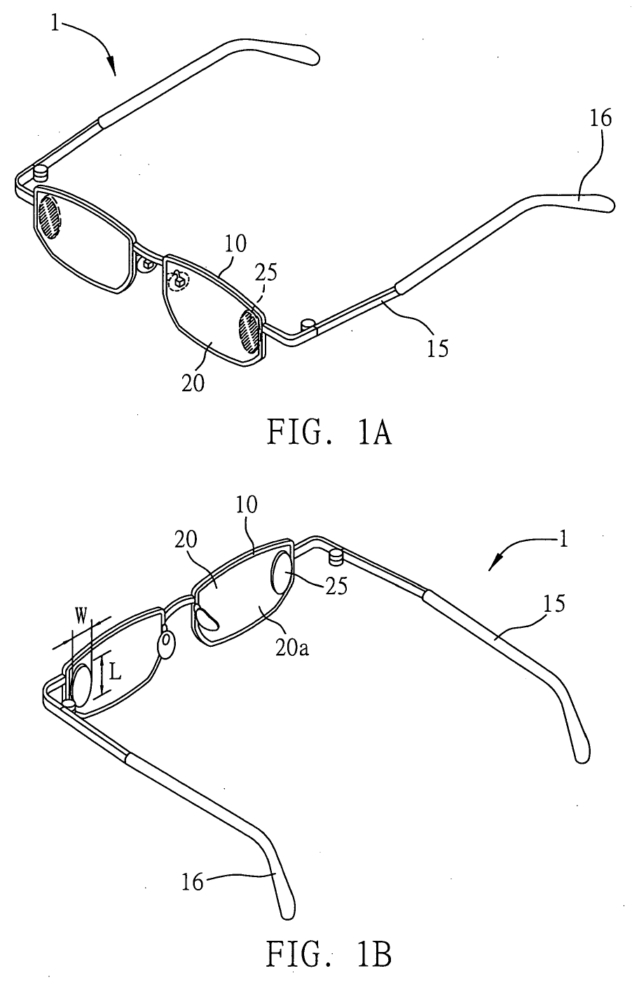

FIG. 1A and FIG. 1B show a pair of safety spectacles 1 according to a preferred embodiment of the present invention. The spectacles 1 include a spectacle frame 10, two extension legs 15, and two spectacle lenses 20. The spectacle frame 10 corresponds in position to eyes of a user and comprises two substantially circular ring parts for holding the two spectacle lenses 20 therein. The spectacle lenses 20 can be made of glass or plastic. The two extension legs 15 are respectively extended from sides of the spectacle frame 10 and each provided with a bent end 16 for hanging on the user's ears when the user wears the spectacles 1, such that the user's eyes can see the front views through the spectacle lenses 20. Since the basic structure of the spectacles is well known in the art, it is not to be further detailed here.

Further as shown in FIG. 1A and FIG. 1B, a characteristic feature of the present invention is to attach a reflecting lens 25 to each of the two spectacle lenses 20 at a position at an edge close to the corresponding extension leg 15. The reflecting lenses 25 are made to comply with the topography of inner surfaces 20a of the spectacle lenses 20 that face the user's eyes. A reflecting surface of each reflecting lens 25 faces the user and is a flat surface. The reflecting lenses 25 are located symmetrically on the spectacle lenses 20 and within the range of a view angle of the user's eyes, such that the user can easily see the views caught by the reflecting lenses 25. The size of the reflecting lenses 25 is preferably not too large. For example, in FIG. 1B, each reflecting lens 25 has a length L greater than its width W so as not to cover a central area of each spectacle lens 20 where the user's eyes straightly see through. The reflecting lenses 25 should have good flatness to provide satisfactory optical reflection and aesthetic effect. The size, shape and location of the reflecting lenses 25 should be determined according to the size of the spectacles 1 and the relative positions of the user's eyes, and thus can be flexibly arranged to match the user's requirement. This is to allow the user who wears the spectacles 1 to clearly see the views caught by the reflecting lenses 25 at a comfortable view angle.

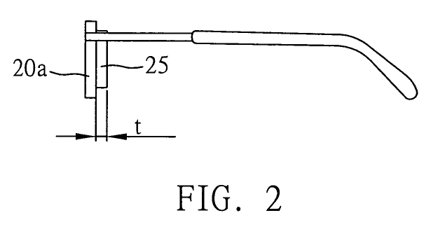

FIG. 2 shows a side view of the spectacles 1. The reflecting lenses 25 have a predetermined thickness t that is not too large so as to reduce the material cost and weight of the spectacles 1.

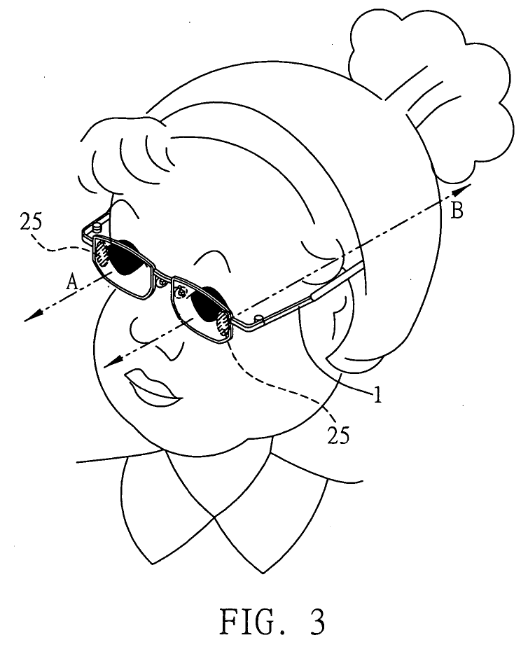

When the user wears the spectacles 1, as shown in FIG. 3, the user can see straightly the front views through the area of the spectacle lenses 20 in the direction as indicated by arrows A, or see the rear views reflected by the reflecting lenses 25 in the direction as indicated by arrows B without having to turn the neck. This enables the user to notice what happens behind to prevent stealing or accidents from occurrence.

The spectacles 1 in the present invention broaden the view angle for the user. The reflecting lenses 25 are easily formed, making the spectacles 1 readily put into mass production without increasing the structural complexity. Therefore, commercial success of fabricating the spectacles 1 is easily achieved.

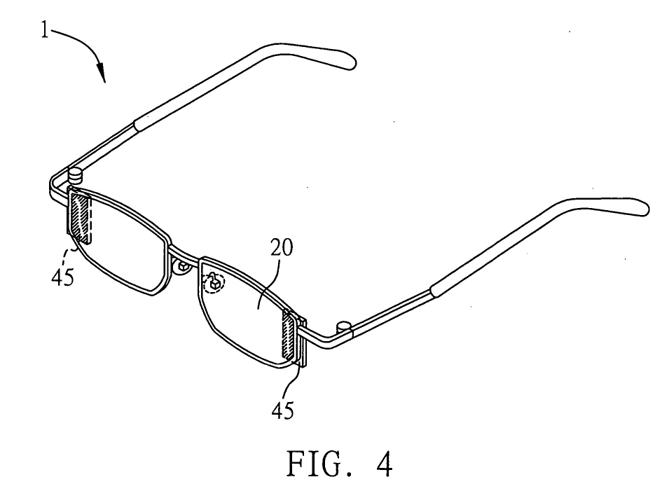

Besides the above reflecting lenses 25, as shown in FIG. 4, a lens device 45 can also be used to provide an optical reflection function for the spectacle lenses 20. The reflecting device 45 comprises a fastener to secure the reflecting device 45 to an edge of each spectacle lens 20, and the two reflecting devices 45 are symmetrically located. This embodiment achieves a more flexible application of the reflecting devices 45. The user may fasten or detach the reflecting devices 45 on or from the spectacles 1 depending on his or her requirement. For example, when the user is in a dark environment or inside a house, the reflecting devices 45 can be separated from the spectacle lenses 20; when the user is in a bright environment or in traffic, the reflecting devices 45 may be assembled with the spectacle lenses 20.

Moreover, besides the foregoing reflecting lenses 25 and reflecting devices 45, a reflecting chemical coating can also be used and applied on the inner surfaces 20a of the spectacle lens 20 at edges close to the extension legs 15. The reflecting chemical coating is cured by a natural cooling or rapid cooling process. The reflecting chemical coating is made to comply with the topography of the inner surfaces 20a of the spectacle lenses 20 that face the user's eyes. This also allows the user to see the rear views reflected by the reflecting chemical coating. The reflecting chemical coating is made of a material, which is not particularly limited but can be any substance or compound having an optical reflection property.

The above embodiments provide a pair of spectacles using reflecting lenses or reflecting coating to allow a user to see the rear views reflected by the reflecting lenses or reflecting coating. This does not set a structural limitation on the spectacles according to the present invention. In case the user intends to see the views other than the rear and front views, the present invention enables the spectacle lenses of the spectacles to be modified in curve topography, making the reflecting lenses or reflecting coating to catch the views at the desired view angles depending on the user's requirement, and thereby providing the user with a wide view angle in the use of the invented spectacles.

Therefore, the safety spectacles in the present invention indeed provide a broadened view angle for a user to notice any accidents immediately and prevent any danger from occurrence. Furthermore, the spectacles are easily manufactured with low cost.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A pair of safety spectacles, comprising:
a spectacle frame;
two extension legs respectively extended from sides of the spectacle frame to allow a user to wear the spectacles via the extension legs;
two spectacle lenses held by the spectacle frame and positioned corresponding to the user's eyes to allow the user to see a front view through the spectacle lenses; and
at least one reflecting lens formed on at least one of the spectacle lenses, making the user see a rear view via the reflecting lens.

2. The pair of safety spectacles of claim 1, wherein the reflecting lens is attached to the spectacle lens.

3. The pair of safety spectacles of claim 1, wherein the reflecting lens is fastened on the spectacle lens.

4. The pair of safety spectacles of claim 1, wherein the reflecting lens is located on a surface of the spectacle lens that faces the user's eyes.

5. The pair of safety spectacles of claim 1, wherein the reflecting lens is located at an edge of the spectacle lens.

6. The pair of safety spectacles of claim 1, wherein the reflecting lens is located at an edge of the spectacle lens close to the extension leg.

7. The pair of safety spectacles of claim 1, wherein the location of the reflecting lens on the spectacle lens is within the range of a view angle of the user's eyes.

8. The pair of safety spectacles of claim 1, wherein a reflecting surface of the reflecting lens faces the user.

9. The pair of safety spectacles of claim 1, wherein a reflecting surface of the reflecting lens is a flat surface.

10. The pair of safety spectacles of claim 1, wherein the reflecting lens comprises a reflecting chemical coating.
